(19) United States
(12) Patent Application Publication
(10) Pub. No.: US 2013/0222241 A1
(43) Pub. Date: Aug. 29, 2013

(54) APPARATUS AND METHOD FOR MANAGING MOTION RECOGNITION OPERATION

(71) Applicant: Woo Kyung JEONG, Seoul (KR)

(72) Inventor: Woo Kyung JEONG, Seoul (KR)

(73) Assignee: PANTECH CO., LTD., Seoul (KR)

(21) Appl. No.: 13/563,717

(22) Filed: Jul. 31, 2012

(30) Foreign Application Priority Data
Feb. 24, 2012 (KR) 10-2012-0019061

(51) Int. Cl. G06F 3/033

(52) U.S. Cl. 345/158

(57) ABSTRACT

Provided is an apparatus and method for managing a motion recognition operation. The apparatus includes a sensor unit to detect a motion; and a motion recognition processing unit to determine a motion event corresponding to the detected motion, to determine an execution event corresponding to the motion event, and to perform the execution event. The method includes detecting a motion using a sensor; determining a motion event corresponding to the detected motion; converting the motion event into an execution event with respect to an application operating in a foreground; and transmitting the execution event to the application.

### CROSS-REFERENCE TO RELATED APPLICATION

This application claims priority from and the benefit of Korean Patent Application No. 10-2012-0019061, filed on Feb. 24, 2012, which is hereby incorporated by reference for all purposes as if fully set forth herein.

### BACKGROUND

1. Field

Exemplary embodiments of the present invention relate to a portable terminal with a motion recognition operation for converting a sensed motion recognition signal into an execution event in an application.

2. Discussion of the Background

A portable terminal with a motion recognition operation may recognize a motion inputted by a user through a sensor and may perform a corresponding operation in response to the sensed motion. Accordingly, the user may enable the portable terminal to perform an intended operation by inputting a motion in the portable terminal without directly pressing a button, a key, or a control mechanism of the portable terminal. The motion recognition operation may be used in a game or an application.

However, the motion recognition operation may be limited to a specific application or applications that support the motion recognition operation.

Accordingly, an event related to a motion recognition operation may be limited to a specialized set of applications capable of processing a motion recognition operation, such as, for example, an electronic book (e-book) application, a game application, a music player application, and the like. Further, these specialized set of applications may respond to a set of motions, which may be different from application to application.

As a result, the following issues may arise.

First, if an application that may not be able to detect or consider a motion recognition operation detects a motion input, the application operation may not be performed. Accordingly, the motion recognition operation may be limited to a specific range of applications that may be programed to respond to the motion recognition operation.

Secondly, a separate motion recognition operation may be designed for each application that seeks to use such capability. For example, a set of motions that may be recognized by a first application may be different from a set of motions that may be recognized by a second application. Programming multiple applications to respond to multiple sets of motions that may be different from one another may be a burden on a developer and reduce compatibility.

Thirdly, since a separate motion recognition operation for each application may be developed, the applications may have different motion scenarios or recognized motions. Accordingly, consistency or standardization of motions that may be used in the motion recognition operation may be reduced, and a user may have difficulty learning various motions to operate different applications utilizing the motion recognition operation.

### SUMMARY

Exemplary embodiments of the present invention provide an apparatus and method for securing information stored in a portable terminal.

Additional features of the invention will be set forth in the description which follows, and in part will be apparent from the description, or may be learned by practice of the invention.

Exemplary embodiments of the present invention provide a method for managing a motion recognition operation including detecting a motion using a sensor; determining a motion event corresponding to the detected motion; converting the motion event into an execution event with respect to an application operating in a foreground; and transmitting the execution event to the application.

Exemplary embodiments of the present invention provide a portable terminal including a sensor unit to sense a motion; and a motion recognition processing unit, including a determining unit to determine a motion event based on the sensed motion; a converting unit to convert a determined motion event into an execution event with respect to an application operating in a foreground; and a transmitting unit to transmit the execution event to the application.

Exemplary embodiments of the present invention provide a portable terminal including a sensor unit to detect a motion; and a motion recognition processing unit to determine a motion event corresponding to the detected motion, to determine an execution event corresponding to the motion event, and to perform the execution event.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating an apparatus to manage a motion recognition operation in a portable terminal according to an exemplary embodiment of the present invention.

FIG. 2 is a diagram illustrating a process for processing a motion recognition operation according to an exemplary embodiment of the present invention.

FIG. 3 is a flowchart illustrating a process for processing a motion recognition operation in a motion recognition processing unit according to an exemplary embodiment of the present invention.

FIG. 4A, FIG. 4B, and FIG. 4C are diagrams illustrating application of a motion recognition operation according to an exemplary embodiment of the present invention.

FIG. 5 is a conversion chart illustrating a correlation of execution events and motion events according to an exemplary embodiment of the present invention.

FIG. 6 is a conversion chart illustrating a correlation of execution events and motion events with respect to a category of an application according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

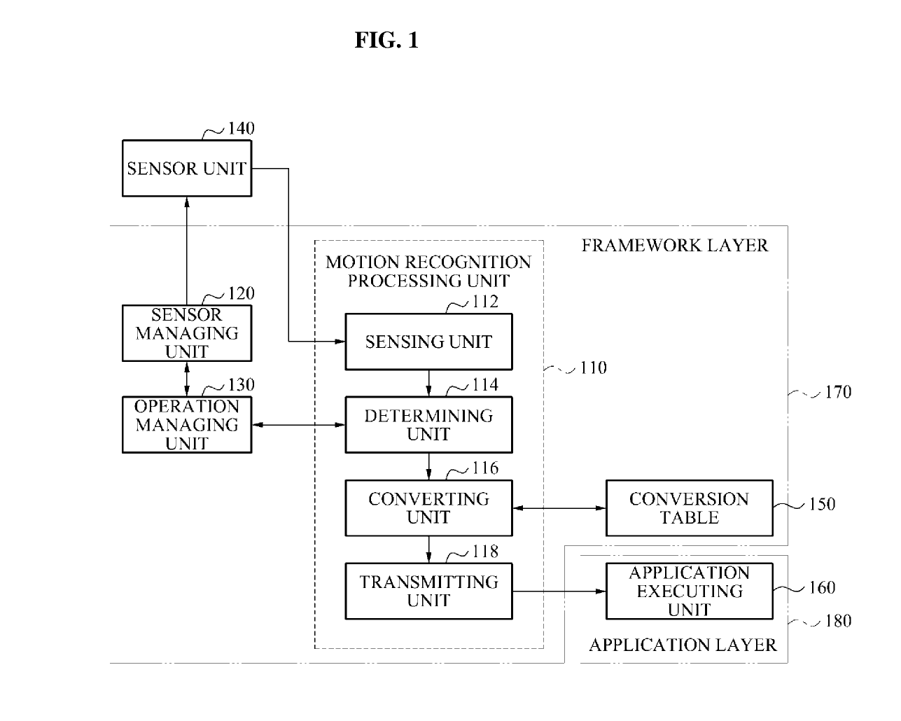

FIG. 1 is a block diagram illustrating an apparatus to manage a motion recognition operation in a portable terminal according to an exemplary embodiment of the present invention.

Referring to FIG. 1, a portable terminal includes a motion recognition processing unit 110, a sensor managing unit 120, an operation managing unit 130, a sensor unit 140, a conversion table 150, and an application executing unit 160.

The sensor unit 140 may include at least one sensor to sense a motion, and may be operated or terminated according to a control of the sensor managing unit 120. The sensor included in the sensor unit 140 may transmit sensing information to the motion recognition processing unit 110. In an example, the sensor may be, without limitation, at least one of a camera sensor, an infrared sensor, a gyro sensor, and an acceleration sensor. In an example, a motion can be a touch or a motion without a touch.

The sensor managing unit 120 may receive information about one or more operations of the portable terminal in progress from the operation managing unit 130. Further, when a start condition or a reference condition of the sensor included in the sensor unit 140 is met, the sensor managing unit 120 may control operation of the sensor. In an example, the sensor start condition may, without limitation, correspond to at least one of activating a display unit, executing an application included in a predetermined category, and executing a predetermined application. For example, the start condition may correspond to activation of a home screen in response to an activation of a display unit, executing a music player application included in a predetermined category, such as a “music player” category, and executing a gallery application as a predetermined application.

Also, when a sensor termination condition is met, the sensor managing unit 120 may order the sensor in operation to cease operation. In an example, the sensor termination condition may include an instance when the sensor start condition fails to be met while the sensor is operational, timing out of the sensor, a user input, and the like.

The operation managing unit 130 may manage execution and termination of an application, and transmission of a message between applications. For an Android®-based portable terminal, an activity manager may perform an operation of the operation managing unit 130.

The motion recognition processing unit 110 may receive sensing information from the sensor and may convert the received sensing information into an execution event that can be processed by an application running in a foreground or an active application. Referring to FIG. 1, the motion recognition processing unit 110 includes a sensing unit 112, a determining unit 114, a converting unit 116, and a transmitting unit 118.

The sensing unit 112 may receive sensing information from at least one sensor based on the sensed motion. More specifically, a sensor included in the sensor unit 140 may sense a motion, and the sensor unit 140 may generate corresponding sensing information based on the sensed motion, which may be transmitted to the sensing unit 112.

The determining unit 114 may determine a motion event using the sensing information received from the sensing unit 112, and may receive information about an application running in a foreground. The motion event may refer to, without limitation, at least one of information obtained by recognizing a motion of an object or a user with the portable terminal within a detection range of the sensor, and information associated with a recognized motion of the portable terminal. More specifically, the motion event may be associated with a motion of an object or a motion of the portable terminal itself, as detected by the sensor.

The determining unit 114 may request and receive the information about the application running in the foreground from the operation managing unit 130.

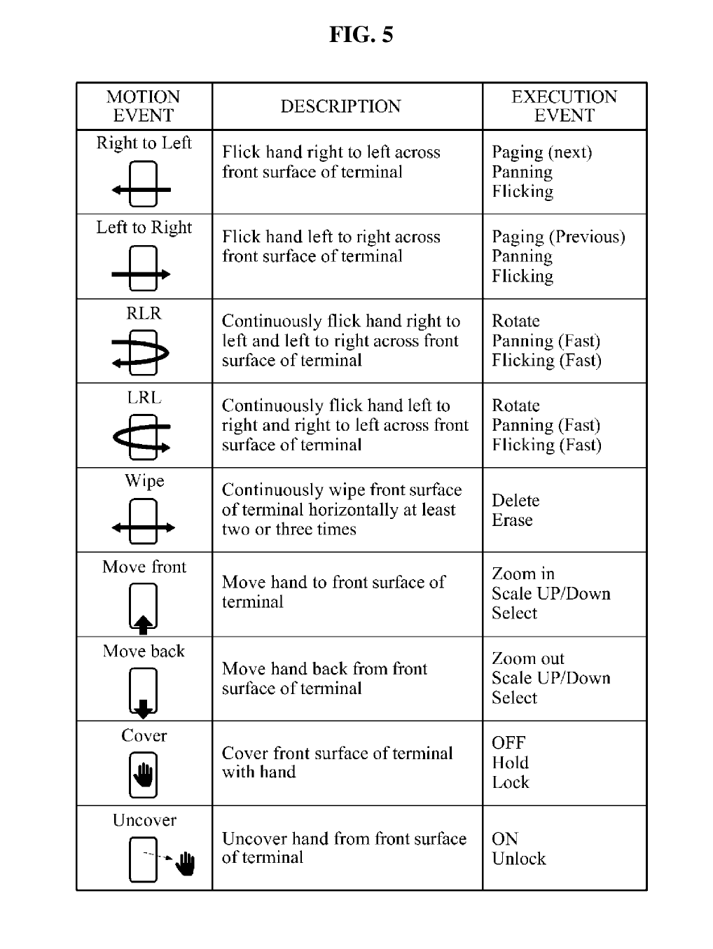

The converting unit 116 may convert a motion event into an execution event corresponding to the application running in the foreground. The execution event corresponding to the motion event may be described in more detail with reference to FIG. 5.

FIG. 5 is a conversion chart illustrating correlation of execution events and motion events according to an exemplary embodiment of the present invention. Referring to FIG. 5, a motion event corresponding to a flicking hand motion moving from right to left across a surface of a terminal may generate an execution event that performs at least one of a paging (i.e., turning a page of a document) operation, a panning operation, and a flicking operation in a first direction or a right to left direction. Similarly, a motion event corresponding to a flicking hand motion moving from left to right across a surface of a terminal may generate an execution event that performs at least one of a paging operation, a panning operation, and a flicking operation in a second direction or a left to right direction. A motion event corresponding to a repeated flicking hand motion moving from a first direction and then in a second direction across a surface of a terminal may generate an execution event that performs at least one of a rotating operation, a fast panning operation, and a fast flicking operation in a first direction. Similarly, a motion event corresponding to a repeated flicking hand motion moving from a second direction and then in a first direction across a surface of a terminal may generate an execution event that performs at least one of a rotating operation, a fast panning operation, and a fast flicking operation in a second direction. A motion event corresponding to a repeated horizontal wiping motion across a surface of a terminal may generate an execution event that performs at least one of a deletion operation or an erasing operation. A motion event corresponding to a moving of a hand towards top of a surface of a terminal may generate an execution event that performs at least one of a zooming in operation, a scaling operation, and a selecting operation. Similarly, a motion event corresponding to a moving of a hand towards bottom of a surface of a terminal may generate an execution event that performs at least one of a zooming out operation, a scaling operation, and a selecting operation. A motion event corresponding to covering a reference portion or proportion of a screen of a terminal may generate an execution event that performs at least one of a powering off operation, a holding operation, and a locking operation. A motion event corresponding to uncovering a reference portion or proportion of a screen of a terminal may generate an execution event that performs at least one of a powering-on operation, and an unlocking operation. While various motions, motion events, and execution events are described in FIG. 5, the aspects of the invention are not limited thereto, such that additional motions, motion events, and execution events may be used.

Although not illustrated, aspects of the invention are not limited to the motion events corresponding to motions of a user's hand, such that the motion events may correspond to a motion of an object, a writing utensil, a user's body parts, and the like. Further, the motion events may correspond to various motions of the terminal. For example, the terminal itself may be moved from right to left to generate an execution event that performs at least one of a paging operation, a panning operation, and a flicking operation in a first direction or a right to left direction.

In addition, at least one of the conversion chart, recognized motion events, motions corresponding to a motion event, and execution events corresponding to the motion events may be defined or updated by the user. Further, specific motions may be assigned to correspond to a motion event that generates an execution event for a foreground application, a background application, or an inactive application.

The converting unit 116 may convert a motion event into an execution event by referring to the conversion table 150 in which an execution event corresponding to a motion event may be pre-stored according to a category of an application.

The conversion table 150 may include an execution event corresponding to a motion event with respect to a category of an application. The conversion table 150 may further include an execution event corresponding to a motion event for an application that may not belong to a specific category. The execution event corresponding to a motion event for an application that may not belong to a specific category may be, without limitation, a touch event or a flick event on a touch screen as shown in FIG. 5.

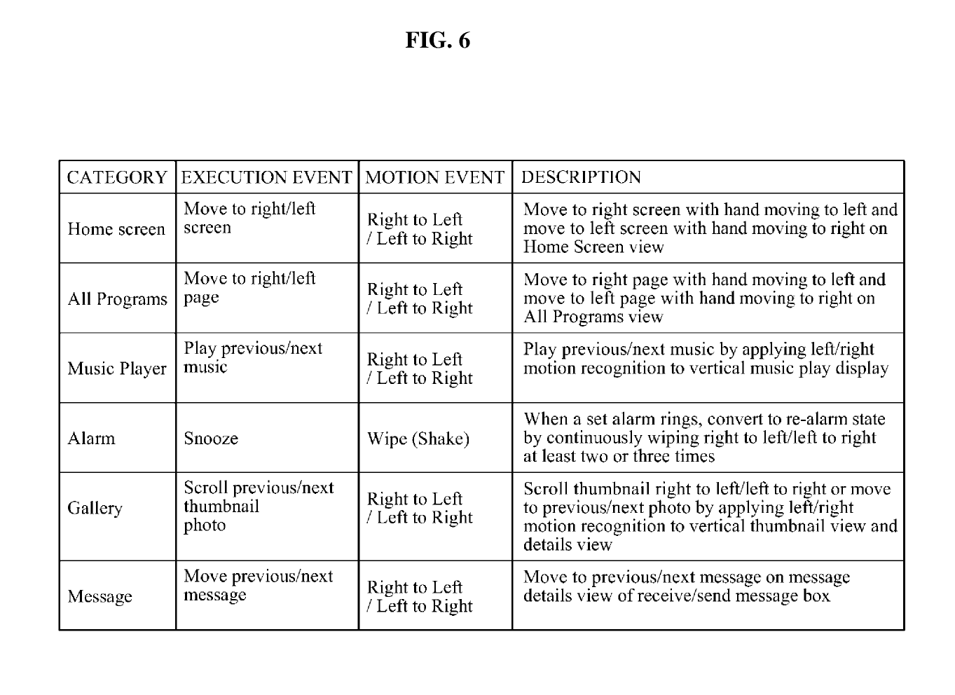

FIG. 6 is a conversion chart illustrating correlation of execution events and motion events with respect to a category of an application according to an exemplary embodiment of the present invention.

Referring to FIG. 6, an execution event corresponding to a motion event may be defined for each category of application. Categories of an application or a program may be predefined according to one or more attributes of the application or the program, customized by a user, and the like. Further, the user may group two or more categories of applications or applications to form a new category. In an example, “all programs” category may refer to an application that may not belong to a specific category. However, aspects of the invention are not limited thereto, such that “all programs” may refer to all programs included in the portable terminal, or programs that may be designated to be part of commonly used programs that may respond to a set of universal motions that are common to one another.

Referring to FIG. 6, a motion event corresponding to a hand motion moving from right to left across a surface of a terminal may vary according to categorization of an application that may be running in the foreground when the motion is detected. However, aspects of the invention are not limited thereto, such that the motion event and/or the execution event may vary according to a categorization of an application running in the background or categorization of an inactive application.

If the category of the application is determined to be a “Home screen”, a cursor on the screen may move in a direction of the detected motion. If the category of the application is determined to be an “All Programs”, a document page or a web page may navigate to another page or a previous page based on a direction of the detected motion. If the category of the application is determined to be a “Music player”, the application may play the next track or the previous track in an album or a playlist based on a direction of the detected motion. If the category of the application is determined to be an “Alarm”, the application may perform a snooze operation. If the category of the application is determined to be a “Gallery”, the application may scroll to a next photo or a previous photo based on a direction of the detected motion. If the category of the application is determined to be a “Message”, the application may move to a previous or a next message based on a direction of the detected motion. While various categories, motions, motion events, and execution events are described in FIG. 6, the aspects of the invention are not limited thereto, such that additional categories, motions, motion events, and execution events may be used.

Although not illustrated, aspects of the invention are not limited to the motion events corresponding to motions of a user's hand, such that the motion events may correspond to a motion of an object, a writing utensil, a user's body parts, a terminal itself, and the like. Further, an application may also be distinguished further by belong to a sub-category or a group.

The transmitting unit 118 may transmit an execution event to an application running in a foreground by the application executing unit 160. However, aspects are not limited thereto, such that the transmitting unit 118 may transmit the execution event to an application running in a background or an application that may not be running if the motion may be determined to be associated with the respective application.

The application executing unit 160 may execute or process an execution event in an application running in the foreground. More specifically, when the application executing unit 160 receives an execution event from the transmitting unit 118, the application executing unit 160 may process the execution event by providing the execution event to the application running in the foreground.

As shown in FIG. 1, the application executing unit 160 may operate in an application layer 180. The motion recognition processing unit 110, the sensor managing unit 120, the operation managing unit 130, the sensor unit 140, and the conversion table 150 may operate in a framework layer 170.

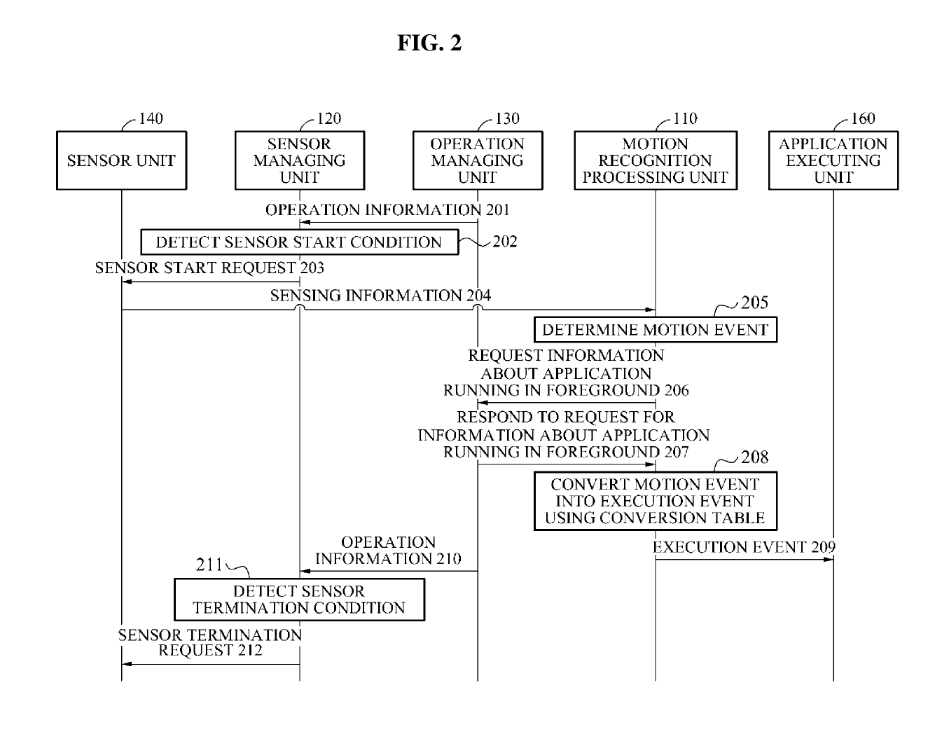

FIG. 2 is a diagram illustrating a process for processing a motion recognition operation according to an exemplary embodiment of the present invention.

Referring to FIG. 2, in operation 201, the sensor managing unit 120 may monitor the operation managing unit 130 or receive information about one or more operations of the portable terminal in progress (e.g., execution of a music player) from the operation managing unit 130. In operation 202, the sensor managing unit 120 may detect a sensor start condition based on the received information on one or more operations in progress. The sensor start condition may, without limitation, correspond to at least one of activation of a display unit, execution of an application included in a predetermined category, and execution of a predetermined application. For example, the sensor start condition may correspond to activation of a home screen in response to a display unit being activated, execution of a music player application included in a predetermined category, such as a “music player” category, and execution of a gallery application as a predetermined application.

In operation 203, when the sensor start condition is detected, the sensor managing unit 120 requests the sensor unit 140 to start a sensor.

In operation 204, after the sensor unit 140 receives the sensor start request, the sensor unit 140 may provide sensing information to the motion recognition processing unit 110. The sensor may include, without limitation, at least one of a camera sensor, an infrared sensor, a gyro sensor, and an acceleration sensor. Sensing information provided by the camera sensor may include images taken during a predetermined period of time. Sensing information provided by the infrared sensor may correspond to information indicating whether an object is located within a reference distance range. Sensing information provided by the gyro sensor may be information indicating a rotation angle of each axis of the portable terminal including the sensor unit 140. Sensing information provided by the acceleration sensor may be information indicating a gravitational acceleration with respect to each axis of the portable terminal. Using the sensing information of at least one of the camera sensor and the infrared sensor, a motion of an object located outside of the portable terminal may be sensed via the sensor unit 140. Using the sensing information of at least one of the gyro sensor and the acceleration sensor, a motion of the portable terminal may be sensed via the sensor unit 140.

In operation 205, the motion recognition processing unit 110 may determine a corresponding motion event using the sensing information. For example, when the motion recognition processing unit 110 receives the sensing information from the camera sensor, the motion recognition processing unit 110 may check or verify a motion of an object by analyzing a frame of an image taken by the camera sensor and determine whether the checked motion of the object is a motion event. Further, the motion recognition processing unit 110 may extract a black and/or white area of an image frame based on a brightness level of one or more pixels in a frame of an image and determine a motion of an object based on a change in the extracted black and/or white area. Further, to reduce the likelihood of an error, the motion recognition processing unit 110 may calculate an average brightness value of one or more image frames captured by the camera sensor, and may extract, as a black and/or white area, a pixel of a predetermined ratio or less relative to the calculated average brightness value.

In operation 206, the motion recognition processing unit 110 may request information about an application running in a foreground from the operation managing unit 130. However, aspects are not limited thereto, such that the motion recognition processing unit 110 may request information associated with applications running in a background of the portable terminal, or applications that may not be executed. In operation 207, the motion recognition processing unit 110 may receive at least the information about the application running in the foreground from the operation managing unit 130.

In operation 208, the motion recognition processing unit 110 converts the determined motion event into an execution event corresponding to the application running in the foreground by referring to the conversion table. For example, if a screen of a portable terminal is covered with a user's hand as a motion event, the conversion table may determine that the motion event corresponds to an execution event that turns off the portable terminal. In operation 209, the motion recognition processing unit 110 provides the determined execution event to the application executing unit 160. In an example, the conversion table may include a list of execution events that may correspond to a motion event according to a category of an application. Further, the conversion table may further include a list of execution events that may correspond to a motion event corresponding to an application that may not belong to a predetermined category. For example, the execution event corresponding to a motion event of an application that does not belong to a predetermined category may be determined as a touch event or a flick event of a touch screen as shown in FIG. 5. However, aspects of the invention are not limited thereto, such that the execution event corresponding to the application that does not belong to a predetermined category may include a rotation event, a zooming event, a deletion event, and the like. The conversion table may be configured as shown in FIG. 5 and FIG. 6, but is not limited thereto.

In operation 210, the sensor managing unit 120 may monitor the operation managing unit 130 or receive information about operations in progress from the operation managing unit 130. In operation 211, the sensor managing unit may detect a sensor termination condition, or determine whether the sensor termination condition was met based on the received information about operations in progress. Here, the sensor termination condition may include a situation where the sensor start condition has failed to be met. More specifically, the sensor termination condition may include at least one of a situation where a display unit is turned off or inactive, where an application used in starting the sensor is terminated, and where an application used in starting the sensor is changed to an application running in the background.

For example, the sensor termination condition include, without limitation, situations in which a display unit is inactivated because no input is sensed for a predetermined time, where a display unit is inactivated by an input requesting a change to a sleep mode, where a music player application or gallery application corresponding to the sensor start condition is terminated, and where a music player application or gallery application corresponding to the sensor start condition is executed in the background.

In operation 212, when the sensor start condition is detected, the sensor managing unit 120 may request the sensor unit 140 to cease operation of the sensor. More specifically, the sensor unit 120 may transmit a sensor termination request to the sensor unit 140 to cease operation of the sensor.

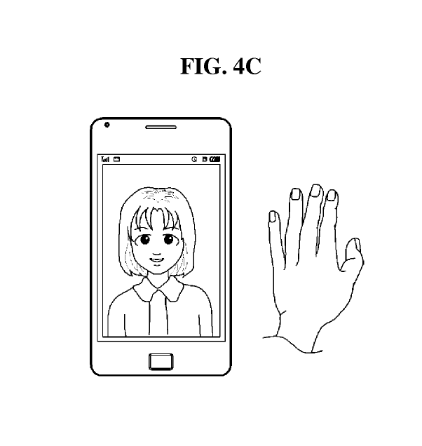

A motion recognition process when a gallery application capable of searching stored photos is executed on the portable terminal is described below with reference to FIG. 4A, FIG. 4B, and FIG. 4C.

FIG. 4A, FIG. 4B, and FIG. 4C are diagrams illustrating application of a motion recognition operation according to an exemplary embodiment of the present invention.

FIG. 4A illustrates a first photo that is displayed in response to an execution of a gallery application according to an exemplary embodiment of the present invention. FIG. 4B illustrates switching of the first photo outputted by the gallery application to a second photo in response to a hand motion of a user according to an exemplary embodiment of the present invention. FIG. 4C illustrates the second photo displayed by the gallery application in response to the hand motion of the user according to an exemplary embodiment of the present invention.

The gallery application of FIG. 4 may not independently provide a service by motion recognition. More specifically, the gallery application of FIG. 4 may perform execution events derived from detected motions that may be recognized by the portable terminal for a category of application corresponding to the gallery application.

When the motion recognition processing unit 110 senses a motion event corresponding to a motion of a user hand moving from left to right while a photo is displayed through the gallery application as shown in FIG. 4A, the motion recognition processing unit 110 may convert the motion event into an execution event corresponding to a flicking operation on a touch screen without actually performing the flicking operation on the touch screen. Also, the motion recognition processing unit 110 may provide the execution event to the gallery application.

The gallery application may change from the state of FIG. 4A to the state of FIG. 4C through executing the execution event illustrated in FIG. 4B.

More specifically, the gallery application may not process a motion event independently, but may execute an execution event corresponding to a motion by receiving and processing the execution event corresponding to a flicking operation, which may be converted by the motion recognition processing unit 110.

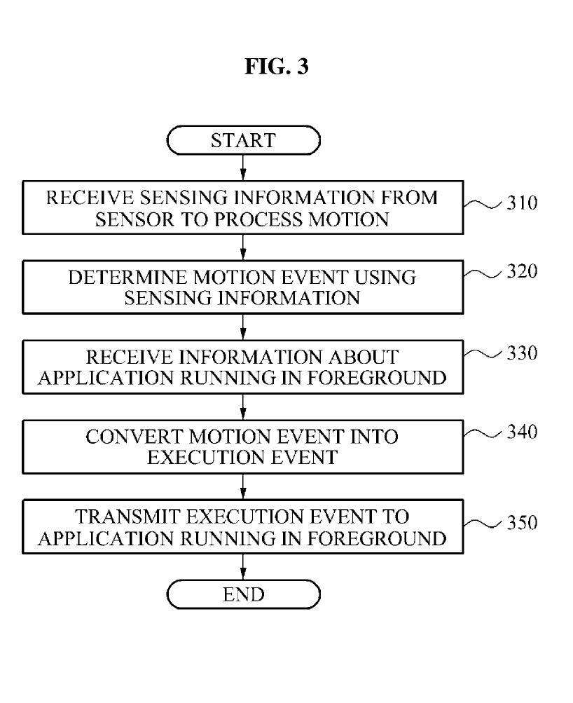

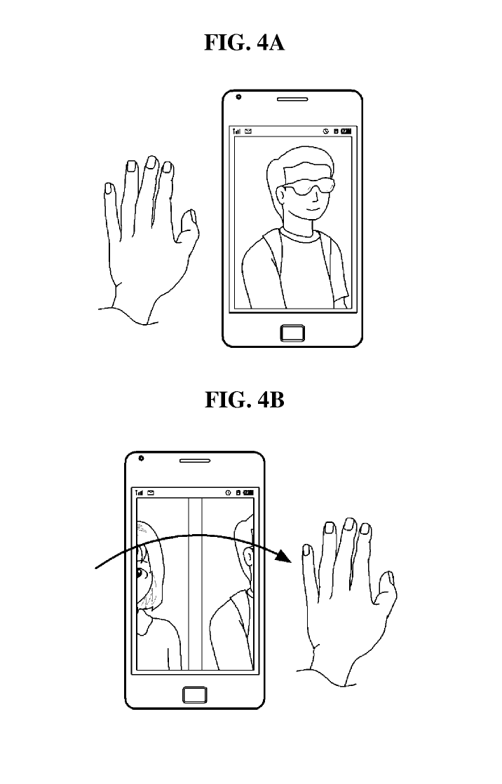

Hereinafter, a method for processing motion recognition according to an exemplary embodiment of the present invention is described with reference to FIG. 3.

FIG. 3 is a flowchart illustrating a process for processing motion recognition in the motion recognition processing unit 110 of the portable terminal according to an exemplary embodiment of the present invention. The method of FIG. 3 will be described as if performed by the portable terminal as shown in FIG. 1, but is not limited as such.

Referring to FIG. 3, in operation 310, the motion recognition processing unit 110 may receive sensing information from at least one sensor to sense a motion.

In operation 320, the motion recognition processing unit 110 may determine a motion event using the sensing information.

In operation 330, the motion recognition processing unit 110 may request and receive information about an application running in the foreground from the operation managing unit 130.

In operation 340, the motion recognition processing unit 110 may convert the motion event into an execution event corresponding to the application running in the foreground by referring to the conversion table 150.

In operation 350, the motion recognition processing unit 110 may transmit the execution event to the application running in the foreground.

Although not illustrated, aspects of the invention are not limited to the applications running in the foreground, such that the method of FIG. 3 may be used with applications running in a background, or inactive applications.

The exemplary embodiments of the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media, such as hard disks, floppy discs, and magnetic tape; optical media, such as CD ROM discs and DVD; magneto-optical media, such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the exemplary embodiments of the present invention, a portable terminal with a motion recognition operation may provide a method for converting a sensed motion recognition signal into an event signal to use the motion recognition operation in a wider range of applications to reduce a burden of developing an individual motion recognition operation for each of the applications, which may hinder or discourage a user from learning to use the motion recognition operation.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method for managing a motion recognition operation, comprising:
detecting a motion using a sensor;
determining a motion event corresponding to the detected motion;
converting the motion event into an execution event with respect to an application operating in a foreground; and
transmitting the execution event to the application.

2. The method of claim 1, wherein the motion is detected in response to detecting a sensor start condition.

3. The method of claim 1, wherein the converting the motion event comprises converting according to a conversion table.

4. The method of claim 3, wherein the conversion table stores a relationship between a list of motion events and a list of corresponding execution events.

5. The method of claim 3, wherein the conversion table stores a relationship between a list of motion events and a list of corresponding execution events with respect to a categorization of the application.

6. The method of claim 1, wherein the determining comprises determining the motion event with respect to a category of the application.

7. The method of claim 1, wherein the detected motion is a motion of a portable terminal.

8. The method of claim 1, wherein the detected motion is a motion of an object located within a reference proximity of the sensor.

9. The method of claim 1, wherein the sensor comprises at least one of a camera sensor, an infrared sensor, a gyro sensor, and an acceleration sensor.

10. A portable terminal, comprising:
a sensor unit to sense a motion; and
a motion recognition processing unit, comprising:
a determining unit to determine a motion event based on the sensed motion;
a converting unit to convert a determined motion event into an execution event with respect to an application operating in a foreground; and
a transmitting unit to transmit the execution event to the application.

11. The portable terminal of claim 10, further comprising a sensor managing unit to control the sensor unit to sense the motion when a start condition of the sensor unit is satisfied.

12. The portable terminal of claim 11, wherein the start condition comprises at least one of activating a display unit, executing an application included in a predetermined category, and executing a predetermined application.

13. The portable terminal of claim 10, wherein the converting unit converts the motion event according to a conversion table.

14. The portable terminal of claim 13, wherein the conversion table stores a relationship between a list of motion events and a list of corresponding execution events.

15. The portable terminal of claim 13, wherein the conversion table stores a relationship between a list of motion events and a list of corresponding execution events with respect to a category of the application.

16. The portable terminal of claim 10, wherein the application belongs to a reference category of applications.

17. The portable terminal of claim 10, wherein the detected motion is a motion of the portable terminal.

18. The portable terminal of claim 10, wherein the detected motion is a motion of an object located within a reference proximity of the sensor.

19. The portable terminal of claim 10, wherein the sensor unit comprises at least one of a camera sensor, an infrared sensor, a gyro sensor, and an acceleration sensor.

20. A portable terminal, comprising:
a sensor unit to detect a motion; and
a motion recognition processing unit to determine a motion event corresponding to the detected motion, to determine an execution event corresponding to the motion event, and to perform the execution event.
